(19) United States
(12) Patent Application Publication
(10) Pub. No.: US 2014/0365454 A1
(43) Pub. Date: Dec. 11, 2014

(54) ENTITY RELEVANCE FOR SEARCH QUERIES

(71) Applicant: MICROSOFT CORPORATION, Redmond, WA (US)

(72) Inventors: LUKE SIMON, REDMOND, WA (US); TAROON MANDHANA, REDMOND, WA (US)

(21) Appl. No.: 13/911,982

(22) Filed: Jun. 6, 2013

(51) Int. Cl. G06F 17/30

(52) U.S. Cl. CPC G06F 17/30864
USPC 707/706; 707/728

(57) ABSTRACT

The relevance of entities to search queries is determined using a triangulation approach. The triangulation approach determines the relevance of entities to documents and the relevance of documents to a search query. The relevance of each entity to the search query is then determined as a function of the relevance of the entities to the documents and the relevance of the documents to the search query. The entity/query relevance determination may be employed when returning a search result experience in response to search queries.

### BACKGROUND

The amount of information and content available on the Internet and/or stored on user devices continues to grow exponentially. Given the vast amount of information, search engines have been developed to facilitate searching. In particular, users may search for information and documents by entering search queries comprising one or more terms that may be of interest to the user. After receiving a search query from a user, a search engine identifies documents, web pages, and/or other content that are relevant based on the terms, and search results may be returned in response to the search query. Typically, the search results are provided on a search engine results page (“SERP”).

Users are often searching for information about a particular entity. Entities are instances of abstract concepts and objects, including people, places, things, events, locations, businesses, movies, and the like. Depending on the search query a user inputs or selects, the SERP may not include information about the particular entity the user is searching or the information may be difficult to find among the many search results returned.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to determining relevance of entities to search queries using a triangulation approach. The triangulation approach determines the relevance of an entity to a search query as a function of the relevance of search result documents to the search query and relevance of the entity to the search result documents. When a search query is received, search result documents may be identified, and relevance of each search result document to the search query may be determined. Additionally, entities discussed in the search result documents and the relevance of each entity to each search document may also be identified. The relevance of each entity to the search query may be determined based on the relevance of the search result documents to the search query and the relevance of each entity to the search result documents. Entity relevance to the search query may be used when providing a search result experience in response to the received search query.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a diagram showing a triangulation approach for determining relevance of an entity to a search query in accordance with an embodiment of the present invention;

FIG. 3 is a block diagram showing a system for providing search results to name search queries in accordance with an embodiment of the present invention;

FIG. 4 is a screenshot showing summary information for a dominant entity on a search results page in accordance with an embodiment of the present invention;

FIG. 5 is a flow diagram showing a method for determining relevance of an entity to a search query in accordance with an embodiment of the present invention; and

FIG. 6 is a flow diagram showing a method for identifying a dominant entity and providing a search results page based on the identification of the dominant entity in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to determining relevance of entities to search queries using a triangulation approach. Search engine result pages often contain heterogeneous search results from numerous different document sources. For a given search query and set of search results, the search results may be closely related to a single dominant entity or a set of entities such as person, place, song, etc. Embodiments of the present invention determine the dominance of one or more entities to a search query using a triangulation technique, which combines the relevance of an entity to each document and the relevance of each document to the search query. Triangulating the dominant entities in this fashion allows for creating a summarization of the search results that is centered on the most dominant entity or entities for a search query. This summarization may, among other things, provide relevant information about the dominant entity or entities and may reinforce with the user how the search engine interpreted the user's search query.

Accordingly, in one aspect, an embodiment of the present invention is directed to a method for identifying relevance of an entity to a search query. The method includes receiving the search query and identifying a plurality of documents based on the search query. The method also includes determining a relevance of each document to the search query and determining a relevance of the entity to each document. The method further includes determining a relevance of the entity to the search query as a function of the relevance of each document to the search query and the relevance of the entity to each document.

In another embodiment, an aspect is directed to one or more computer storage media comprising computer-useable instructions that, when used by one or more computing devices, cause the one or more computing devices to perform a method. The method includes receiving a search query and identifying a plurality of documents based on the search query. The method also includes, for each document, determining a relevance of the document to the search query, and accessing entity information indexed for the document in a search engine index, the entity information identifying a relevance of each of one or more entities to the document. The method further includes determining a relevance for each of a plurality of entities to the search query, the relevance for each entity to the search query being determined based at least in part on the relevance of the entity to each document and the relevance of each document to the search query. The method still further includes identifying a first entity as a dominant entity based on the relevance for each of the plurality of entities to the search query, and providing a search results page generated based at least in part on identifying the first entity as the dominant entity.

A further embodiment of the present invention is directed to a computerized system that includes one or more processors and one or more computer storage media. The system further includes a document understanding component, a document relevance component, an entity/query relevance component, and a user interface component. The document understanding component is configured to identify one or more entities discussed in each of a plurality of documents and determine a relevance of each entity to each document. The document relevance component is configured to identify a set of relevant documents based on a search query and a relevance of each relevant document from the to the search query. The entity/query relevance component configured to identify a relevance of one or more entities to the search query based on the relevance of each relevant document to the search query and the relevance of each of the one or more entities to each relevant document. The user interface component is configured to provide a search results page generated at least in part based on the relevance of the one or more entities to the search query.

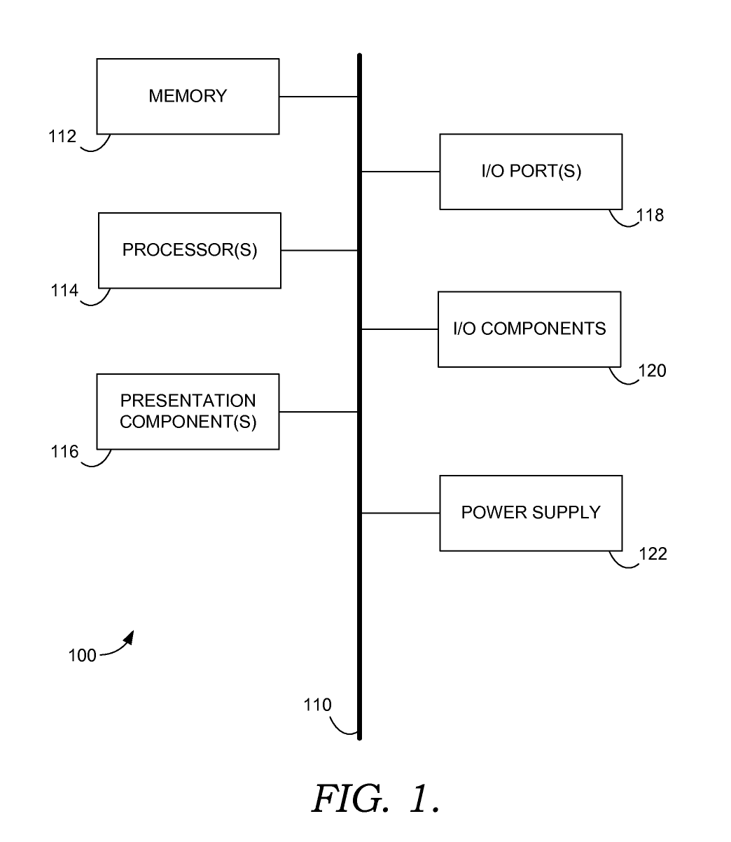

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output (I/O) ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc. The I/O components 120 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as, stereoscopic camera systems, infrared camera systems, RGB camera systems, and combinations of these for gesture detection and recognition. Additionally, the computing device 100 may be equipped with accelerometers or gyroscopes that enable detection of motion. The output of the accelerometers or gyroscopes may be provided to the display of the computing device 100 to render immersive augmented reality or virtual reality.

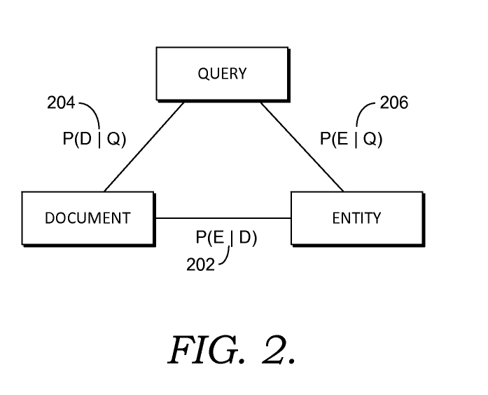

As discussed above, embodiments of the present invention are generally directed to determining the relevance of entities to a search query using a triangulation approach. FIG. 2 is a diagram illustrating this triangulation approach. As shown in FIG. 2, this approach includes determining the relevance 202 of entities to documents. Generally, document analysis techniques can be used to identify entities mentioned, discussed, or otherwise referenced in a document, and an estimate of the relevance of each entity to the document can be determined. The relevance of an entity to a document may include an estimate of P(Entity|Document), which is the probability of the entity given the document.

In some embodiments, the document analysis performed to identify entities within documents and the relevance of those entities to the documents may be done offline and each document may be “stamped” with the entities mentioned in the document, and each of these “stamps” can include an estimate of the relevance of the entity to the document. In other words, entity information may be indexed by a search engine for documents to indicate the entities mentioned by each document and the relevance of the entities to the documents.

The triangulation technique may also rely on an estimate of the relevance 204 of documents to a given search query. In terms of conditional probabilities, this is an estimate of P(Document|Query), which is the probability of the document given the search query.

During query time, N search result documents may be returned for a search query received at a search engine. Entities discussed in the search result documents can be identified (e.g., by retrieving information indexed for the documents), and the relevance 206 of each entity to the search query may be determined through a triangulation technique that combines the above-discussed two relevance estimates (i.e., the relevance 202 of entities to documents and the relevance 204 of documents to the search query). This may include an estimate P(Entity|Query), which is the probability of the entity given the query, as represented in the formula below.

$$P ( Entity \vert Query ) = {\sum }_{k = 1}^{N} [ P ( Entity \vert {Document}_{k} ) \times P ( {Document}_{k} \vert Query ) ]$$

Note that the above formula may assume that P(Entity|Query, Document)=P(Entity|Document), which is a safe assumption since the relevance of an entity to the document is not dramatically different for any given search query.

In practice, there may be many different techniques employed to derive estimates of the relevance of an entity to a document (i.e., P(Entity|Document)) and the relevance of a document to a search query (i.e., P(Document|Query)). Any and all combinations of these estimates can be leveraged to create many difference estimates of the relevance of entities to the search query, and each one of these estimates can be combined using, for instance, supervised machine learning.

If the relevance of an entity to a given search query is high enough, the entity may be identified as a dominant entity, and a search results experience may be provided based on the dominant entity. For instance, a search results page may be provide that includes, with other search results, a dominant entity summary area that displays images, facts, and/or other information that gives an overview of the dominant entity. In other instances in which a dominant entity is not identified (e.g., no entity has a sufficiently high relevance), an entity disambiguation search results experience may be provided. For instance, a search results page may be provided that identifies a number of entities and allows the user to select an entity to disambiguate the search.

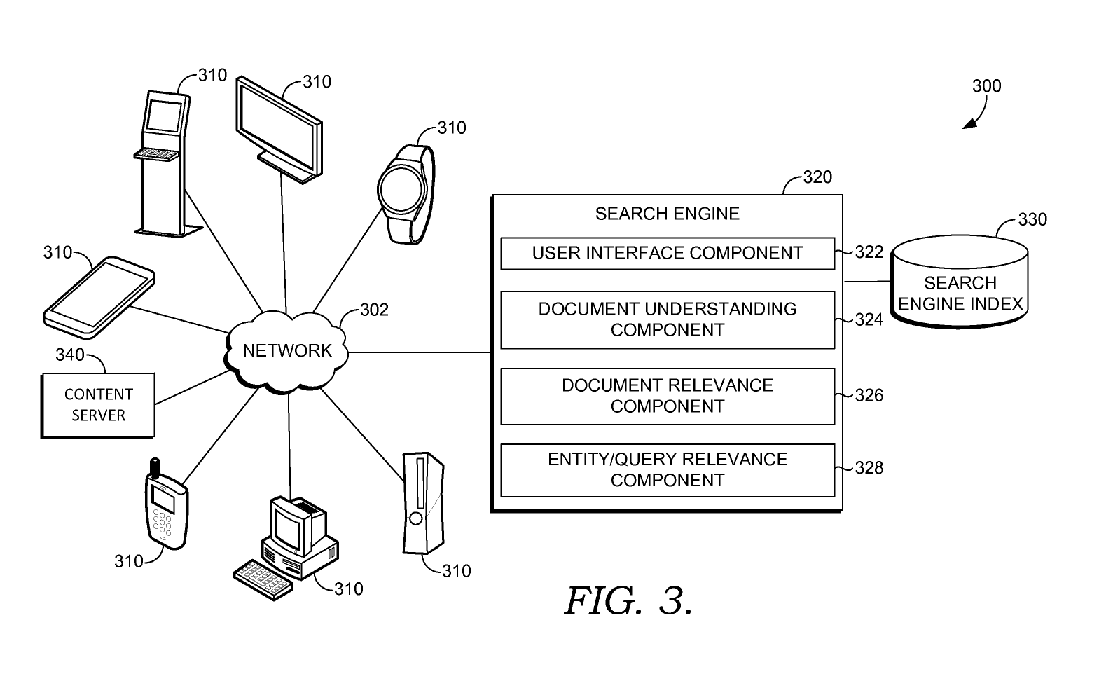

Referring now to FIG. 3, a block diagram is provided illustrating an exemplary computing system 300 in which embodiments of the present invention may be employed. Generally, the computing system 300 illustrates an environment in which entity relevance may be determined for search sessions. Among other components not shown, the computing system 300 generally includes user computing devices 310 (e.g., mobile device, television, kiosk, watch, touch screen or tablet device, workstation, gaming system, internet-connected consoles, and the like) and a search engine 320 in communication with one another via a network 302. The network 302 may include, without limitation, one or more local area networks (LANs) and/or wide area networks (WANs). Such networking environments are commonplace in offices, enterprise-wide computer networks, intranets and the Internet. Accordingly, the network 302 is not further described herein.

It should be understood that any number of user computing devices 310 and/or search engines 320 may be employed in the computing system 300 within the scope of embodiments of the present invention. Each may comprise a single device/interface or multiple devices/interfaces cooperating in a distributed environment. For instance, the search engine 320 may comprise multiple devices and/or modules arranged in a distributed environment that collectively provide the functionality of the search engine 320 described herein. Additionally, other components or modules not shown also may be included within the computing system 300.

In some embodiments, one or more of the illustrated components/modules may be implemented as stand-alone applications. In other embodiments, one or more of the illustrated components/modules may be implemented via a user computing device 310, the search engine 320, or as an Internet-based service. It will be understood by those of ordinary skill in the art that the components/modules illustrated in FIG. 3 are exemplary in nature and in number and should not be construed as limiting. Any number of components/modules may be employed to achieve the desired functionality within the scope of embodiments hereof. Further, components/modules may be located on and/or shared by any number of search engines and/or user computing devices. By way of example only, the search engine 320 might be provided as a single computing device (as shown), a cluster of computing devices, or a computing device remote from one or more of the remaining components Additionally, although the search engine 320 is shown separate from the user computing devices 310, in some embodiments, the search engine 320 may be provided on a user computing device 310.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The user computing device 310 may include any type of computing device, such as the computing device 100 described with reference to FIG. 1, for example. Generally, the user computing device 310 includes a display and is capable of initiating a search and/or acting as a host for presenting search results. The user computing device 310 may be configured to receive user input of requests for various web pages (including search engine home pages), receive user input search queries, receive user input to refine search queries (generally input via a user interface provided on the display and permitting alpha-numeric, voice, motion/gesture, and/or textual input into a designated search input region), and to receive content for presentation on the display, for instance, from the search engine 320. It should be noted that the functionality described herein as being performed by the user device 310 and/or search engine 320 may be performed by any operating system, application, process, web browser, web browser chrome or via accessibility to an operating system, application, process, web browser, web browser chrome, or any device otherwise capable of executing a search or acting as a host for search results. It should further be noted that embodiments of the present invention are equally applicable to mobile computing devices and devices accepting touch, gesture, and/or voice input. Any and all such variations, and any combination thereof, are contemplated to be within the scope of embodiments of the present invention.

The search engine 320 generally operates to index information regarding documents served by content servers, such as the content server 340, in a search engine index 330 to facilitate provide search results identifying documents on content servers. In some cases, the search engine 320 may alternatively or additionally operate to index information stored on a user computing device 310 to facilitate a user searching for information on the user computing device 310. As used herein, the term “document” may refer to any type of electronic content, such as a web page, image, video, for which information may be indexed in the search engine index 330.

When the search engine 320 receives search queries from user computing devices 310, the search engine 320 queries the search engine index 330 to identify search results based on the users' search queries and returns those search results to the user devices. In accordance with embodiments of the present invention, the search engine 320 is also configured to, among other things, determine relevance of entities to search queries. Further, the search engine 320 may provide search results generated based at least in part on the entity relevance determination. This may include, for instance, providing search result pages that provide entity summary information and/or entity disambiguation options based on entity relevance determinations.

As illustrated, in various embodiments, the search engine 320 includes a user interface component 322, a document understanding component 324, a document relevance component 326, and an entity/query relevance component 328. The illustrated search engine 320 also has access to a search engine index 330. As noted above, the search engine index 330 stores information about documents to facilitate providing search results. In accordance with embodiments, the information stored for documents may include entity information, including identification of entities discussed within the documents and the relevance of the entities to the documents. It will be understood and appreciated by those of ordinary skill in the art that the information stored by the search engine index 330 may be configurable and may include any information relevant to search queries/terms/histories, entity identifications, entities, and metadata associated with the entities. The content and volume of such information are not intended to limit the scope of embodiments of the present invention in any way. Further, though illustrated as a single component, the search engine index 330 may, in fact, be a plurality of storage devices, for instance a database cluster, portions of which may reside in association with the user computing device 310, another external computing device (not shown), and/or any combination thereof.

The document understanding component 324 is configured to analyze documents (e.g., documents crawled on content servers, such as content server 340) to identify entities discussed or otherwise referenced on the documents. Additionally, the document understanding component 324 may operate to determine the relevance of a given entity referenced on a document to the document. Any number of different approaches could be used to identify an entity within a document and determine the relevance of the entity to the document. By way of example only and not limitation, relevance determination may employ multinomial naïve bayes or latent Dirichlet allocation techniques. In some embodiments, a single approach may be used for entity identification and/or relevance determination. In other embodiments, multiple approaches may be used in combination to derive the entity relevance. The document understanding component 324 may identify one or more entities referenced within a given document and may determine a relevance for each of those entities to the document. For instance, a web page primarily discussing Barack Obama may mention other people, such as Joe Biden and Michele Obama. The document understanding component 324 may identify each of these entities discussed on the web page and also determine a relevance of each entity to the web page. Because the web page is primarily discussing Barack Obama, the relevance determination would be greatest for Barack Obama and lower for the other people discussed on the web page.

While document understanding could be performed at run time after a search query has been received, in some embodiments, the document understanding component 324 may operate as an offline component to analyze documents and index information in the search engine index 330. In particular, information may be stored in the search engine index 330 in association with indications of documents to identify entities relevant to each document and the corresponding relevance of each entity to each document. The search engine index 330 may be continuously and/or periodically refreshed with information as the search engine 320 analyzes new documents and/or re-analyzes previously indexed documents.

When a search query is received from a user computing device 310, for instance, via the user interface component 322, the document relevance component 326 operates to determine the relevance of search result documents to the received search query. In particular, the search engine index 330 is queried to identify relevant search result documents. The relevance of each of those documents to the search query may be determined based on any of a variety of different search algorithms/approaches. In some cases, a single search algorithm/approach may be employed, while in other instances, multiple search algorithms/approaches may be used in combination to determine the relevance of each document to the search query. By way of example and not limitation, the search approach may employ various statistical techniques and/or machine learning techniques to generate relevance estimates based on various signals. The relevance estimate for a given document may be an estimate of, for instance, a probability a user is going to select the document and/or what relevance a panel of human judges would give to the document given the search query.

The entity/query relevance component 328 identifies entities referenced by the search result documents for the received search query (based on the document understanding component 324 and/or information indexed in the search engine index 330). Additionally, the entity/query relevance component 328 determines a relevance of each entity to the search query. Generally, for a given entity, the relevance of the entity to the search query may be determined as a function of the relevance of the entity to each search result document (as determined by the document understanding component 324 and/or indexed in the search engine index 330) and the relevance of each search result document to the search query (as determined by the document relevance component 326).

The entity/query relevance information determined by the entity/query relevance component 328 may be employed in the process of selecting search result information in response to a search query, which may be returned to a user computing device 310 via the user interface component 322. In some embodiments, a single entity may be identified as a dominant entity based on the entity/query relevance information. An entity may be identified as a dominant entity in a number of different manners. In some cases, an entity with the highest relevance to the search query is identified as the dominant entity. In other cases, an entity is determined to be the dominant entity only if the entity has the highest relevance to the search query and the entity's relevance to the search query exceeds a relevance threshold (predetermined or dynamic). In further cases, an entity may be determined to be the dominant entity only if the entity's relevance to the search query is significantly greater than the relevance for all other entities. Any and all combinations and variations thereof are contemplated to be within the scope of embodiments of the present invention.

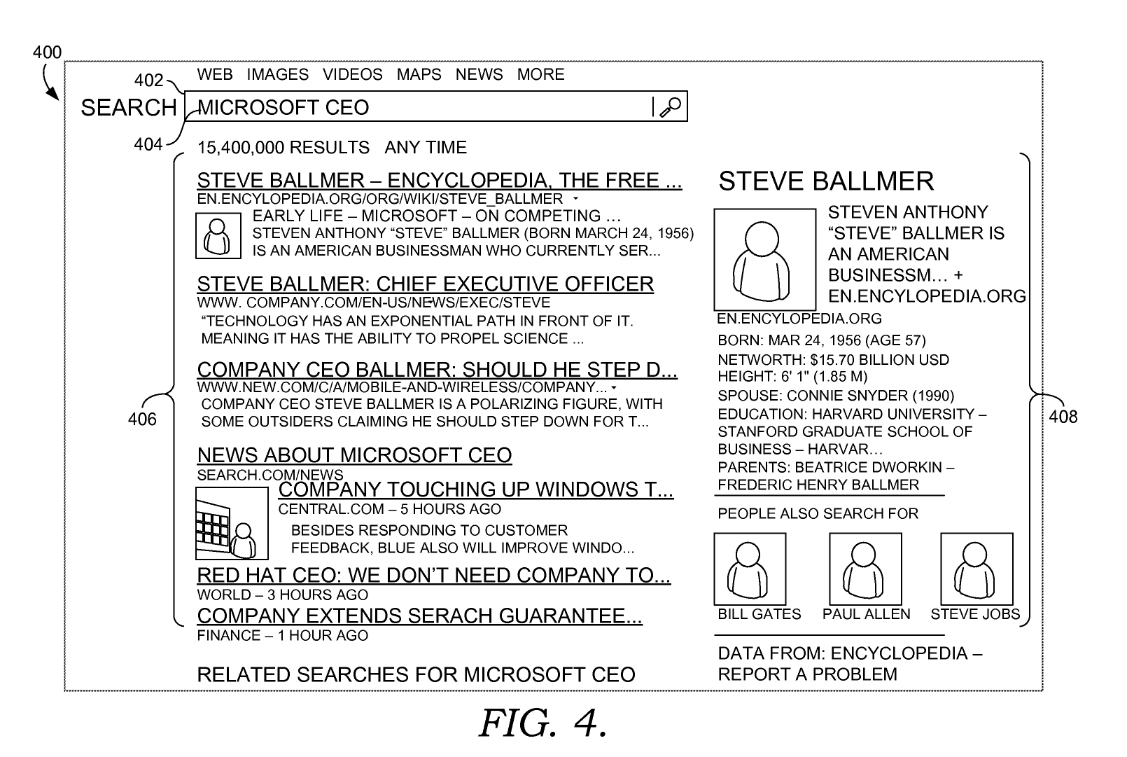

Identification of a dominant entity may be used to generate search result information provided in response to the search query in a variety of different ways. For instance, entity summary information may be provided in addition to a search result listing on a search results page. An example of this is illustrated in FIG. 4, which shows a screenshot of a search results page 400 in accordance with an embodiment of the present invention. As shown in FIG. 4, a search results page 400 is provided that includes a search box 402 with a search query 404. Based on this search query, a list of search results 406 is provided. Additionally, a dominant entity has been identified and a dominant entity area 408 is provided with the list of search results 406 to provide summary information for the dominant entity. In the present example of FIG. 4, the user has entered the search query “microsoft ceo.” In response, Steve Ballmer has been identified as a dominant entity for the search query and information regarding Steve Ballmer is provided in the dominant entity area 408.

The identification of the dominant entity could also be used to affect the search results provided. For instance, the ordering of search results returned could be based in part on the relevance of the dominant entity to each search result document. This could include providing increased ranking to search result documents for which the dominant entity has a higher relevance.

In other embodiments, instead of identifying a dominant entity, multiple entities may be selected. This may occur in situations in which a dominant entity may not be present based on the entity/query relevance information, such as when the search query is ambiguous. For instance, a search query “jaguar” may be ambiguous as the user could be searching for information regarding the animal, the car manufacturer, the NFL football team, or some other entity. In such situations, multiple entities may have a relevance to the search query that exceeds some threshold or no entities may have a relevance to the search query that exceeds the threshold.

When multiple entities are selected, a number of search result experiences could be provided. In some instances, summary information may be provided for each of the selected entities in conjunction with a list of search results. This may depend on the number of entities selected and the screen space available for presenting the summary information. In some instances, a disambiguation experience may be provided. For instance, search result listings may be aggregated into different entity groups based on entity relevance for each search result document. Additionally or alternatively, user-selectable options may be provided that allow the user to make a disambiguation choice, selecting one of the identified entities for which the user is seeking information. A search result experience could be provided based on the user's selection, such as a search results page with summary information for the selected entity and/or search results selected and/or ordered based on the selected entity.

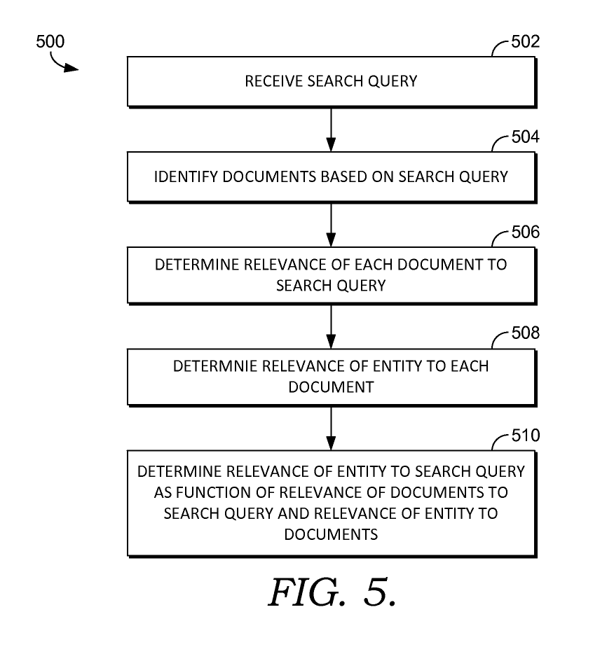

With reference now to FIG. 5, a flow diagram is provided that illustrates a method 500 for determining relevance of an entity to a search query. As shown at block 502, a search query is received. Documents are identified based on the search query, as shown at block 504. Generally, a search engine index, such as the search engine index 330 of FIG. 3, may be queried based on the search query to identify relevant documents. The relevance of each of the documents to the search query is determined at shown at block 506. As noted above, any of a variety of different search algorithms may be employed to determine the relevance of each document to the search query. A single algorithm may be used by itself or multiple algorithms may be used in combination. Although blocks 504 and 506 are shown as separate blocks, it should be understood that the process of identifying relevant documents and determining the relevance of each document to the search query may be performed in a single step or a combination of steps within the scope of embodiments of the present invention.

The relevance of a particular entity to identified documents is determined at block 508. In some embodiments, the relevance of entities to documents may be determined in a background or offline process, and information regarding the entity relevance may be stored in a search engine index, such as the search engine index 330 of FIG. 3, or other storage component. In some embodiments, the entity relevance information may be stored in association with other information indexed for each document that is typically used for selecting search results for search queries. When entity relevance information is indexed for documents, the indexed information may be retrieved to determine the relevance of the entity for identified documents at block 508. Alternatively, if entity relevance information is not indexed, the relevance may be calculated at runtime at block 508.

The relevance of the particular entity to the search query is determined at block 510 as a function of the relevance of the documents to the search query and the relevance of the particular entity to the documents. The relevance of the entity to the search query may be used in returning search results in response to the search query. For instance, the relevance of the entity to the search query may be used to identify the entity as a dominant entity and a search result experience returned based on the entity being identified as a dominant entity. In other embodiments, the entity may be selected with one or more other entities based on relevance of the entities to the search query, and a disambiguation search result experience may be provided based on those entities.

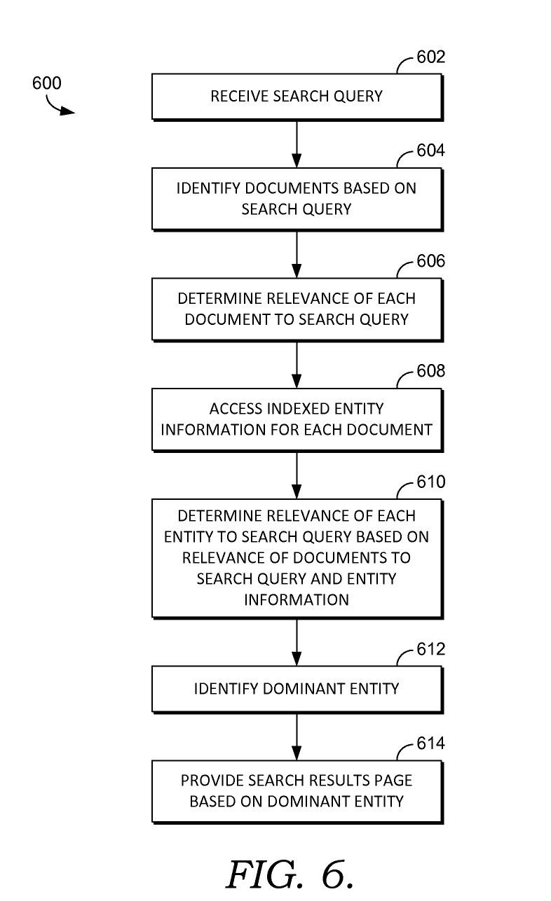

Turning now to FIG. 6, a flow diagram is provided that illustrates a method 600 for identifying a dominant entity and providing a search results page based on the identification of the dominant entity. As shown at block 602, a search query is received. Documents are identified based on the search query, as shown at block 604. As discussed above with reference to FIG. 5, relevant documents may be identified, for instance, by querying a search engine index. The relevance of each of the documents to the search query is determined at block 606 using any of a variety of different search algorithms alone or in combination. Although blocks 604 and 606 are shown as separate blocks, it should be understood that the process of identifying relevant documents and determining the relevance of each document to the search query may be performed in a single step or a combination of steps within the scope of embodiments of the present invention.

Indexed entity information is retrieved at block 608 for each identified document and/or each with relevance to the search query above a certain threshold (or other subset of identified documents). In particular, the documents may have been processed previously to identify entities discussed in the documents and to calculate the relevance of each entity discussed in each document to the document in which it is discussed. As such, the search engine index may identify for each document, each entity discussed in the document and the relevance of each entity to the document.

The relevance of each entity to the search query is determined at block 610 as a function of the relevance of the documents to the search query and entity information accessed at block 608. The entity information used to determine the relevance of each entity to the search query includes a relevance of each entity to the documents. A dominant entity is determined at block 612 based on each entity's relevance to the search query. A dominant entity may be identified in a number of different ways within the scope of embodiments of the present invention. For example, an entity with the greatest relevance to the search query may be identified as the dominant entity. In some cases, the entity must have a relevance to the search query that excess a relevance threshold to be considered the dominant entity.

A search results page generated at least in part based on the dominant entity is provided at block 614. In some embodiments, an entity summary area may be included on the search results page to provide general information about the dominant entity. The entity summary area may be provided in addition to search results selected based on the search query. In some embodiments, the search result selection and/or ranking (i.e., ordering) may be based at least in part on the dominant entity. For instance, search results for documents for which the dominant entity has a higher relevance may be given greater ranking so the search results appear higher in the search result listing.

As can be understood, embodiments of the present invention provide a triangulation approach for estimating the relevance of entities to a given search query as a function of the relevance of search result documents to the search query and relevance of the entities to the search result documents. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A method for identifying relevance of an entity to a search query, the method comprising:
receiving the search query;
identifying a plurality of documents based on the search query;
determining a relevance of each document to the search query;
determining a relevance of the entity to each document; and
determining a relevance of the entity to the search query as a function of the relevance of each document to the search query and the relevance of the entity to each document.

2. The method of claim 1, wherein determining a relevance of the entity to each document comprises accessing entity relevance information for each document from a search engine index.

3. The method of claim 1, wherein the search query is received from an end user, and wherein the method further comprises providing, for presentation to the end user, a search results page generated at least in part based on the relevance of the entity to the search query.

4. The method of claim 1, wherein the method further comprises identifying a relevance of each of a plurality of other entities to the search query.

5. The method of claim 4, wherein the method further comprises identifying the entity as a dominant entity.

6. The method of claim 5, wherein the method further comprises identifying the entity as the dominant entity based on the relevance of the entity to the search query being above a threshold and the relevance of each of the plurality of other entities to the search query being below the threshold.

7. The method of claim 5, wherein the method further comprises providing a search results page generated at least in part based on identifying the entity as the dominant entity.

8. The method of claim 7, wherein providing the search results page generated at least in part based on identifying the entity as the dominant entity comprises providing entity summary information for the entity within a portion of the search results page.

9. The method of claim 8, wherein the entity summary information comprises at least one selected from an image of the entity, one or more facts regarding the entity, and an indication of one or more other entities related to the entity.

10. The method of claim 7, wherein providing the search results page generated at least in part based on identifying the entity as the dominant entity comprises ordering at least a portion of the plurality of documents on the search results page based at least in part on the entity.

11. The method of claim 3, wherein the method further comprises:
selecting the entity and one or more other entities based on the relevance of the entity to the search query and the relevance of the one or more other entities to the search query; and
providing a search results page generated based at least in part based on the entity and the one or more other entities.

12. The method of claim 11, wherein the search results page includes an entity disambiguation graphical element that allows a user to select an entity.

13. The method of claim 11, wherein the search results page includes entity summary information for the entity and the one or more other entities.

14. One or more computer storage media comprising computer-useable instructions that, when used by one or more computing devices, cause the one or more computing devices to perform a method comprising:
receiving a search query;
identifying a plurality of documents based on the search query;
for each document:
(a) determining a relevance of the document to the search query, and
(b) accessing entity information indexed for the document in a search engine index, the entity information identifying a relevance of each of one or more entities to the document; and
determining a relevance for each of a plurality of entities to the search query, the relevance for each entity to the search query being determined based at least in part on the relevance of the entity to each document and the relevance of each document to the search query;
identifying a first entity as a dominant entity based on the relevance for each of the plurality of entities to the search query; and
providing a search results page generated based at least in part on identifying the first entity as the dominant entity.

15. The one or more computer storage media of claim 14, wherein the relevance of each document to the search query is determined based on information indexed in the search engine index.

16. The one or more computer storage media of claim 14, wherein the search results page includes entity summary information for the first entity.

17. A computerized system comprising:
one or more processors; and
one or more computer storage media storing:
a document understanding component configured to identify one or more entities discussed in each of a plurality of documents and determine a relevance of each entity to each document;
a document relevance component configured to identify a set of relevant documents based on a search query and a relevance of each relevant document from the to the search query;
an entity/query relevance component configured to identify a relevance of one or more entities to the search query based on the relevance of each relevant document to the search query and the relevance of each of the one or more entities to each relevant document; and
a user interface component configured to provide a search results page generated at least in part based on the relevance of the one or more entities to the search query.

18. The computerized system of claim 17, wherein the entity/query relevance component identifies a dominant entity based on the relevance of the one or more entities to the search query, and wherein the search results page includes a listing of search results and an entity summary area that includes information about the dominant entity.

19. The computerized system of claim 17, wherein the entity/query relevance component identifies a set of dominant entities based on the relevance of the one or more entities to the search query, and wherein the search results page is generated at least in part on the set of dominant entities.

20. The computerized system of claim 19, wherein the search results page provides a disambiguation search result experience that identifies each entity from the set of dominant entities.
